(19) United States
(12) Patent Application Publication
(10) Pub. No.: US 2012/0330746 A1
(43) Pub. Date: Dec. 27, 2012

(54) ANALYTICS SYSTEM AND METHOD FOR MONITORING CONSUMER INTERACTION WITH MERCHANT PROMOTIONAL ACTIVITIES

(76) Inventor: Dave Gasparine, Las Vegas, NV (US)

(21) Appl. No.: 13/168,763

(22) Filed: Jun. 24, 2011

(51) Int. Cl. G06Q 30/00

(52) U.S. Cl. 705/14.44

(57) ABSTRACT

An analytics system for monitoring consumer interactions with promotional activities provides rapid feedback to merchants engaging in promotional activity to increase consumer traffic, purchases, and knowledge with regard to the merchants' businesses. The analytics system may distribute one or more promotions to consumers electronically. An activity monitor of the analytics system may monitor and collect information regarding consumer interactions or activities surrounding the promotions. For example, the viewing, sharing, or redemption of particular promotions on a consumer's mobile or other device may be collected. This information may then be used to provide feedback to merchants regarding the results, success, or lack thereof of one or more of their promotions.

### BACKGROUND OF THE INVENTION

1. Field of the Invention

The invention relates generally to transaction monitoring systems, and in particular to an analytics system and method for coupon purchases.

2. Related Art

Advertisements, promotions, and other marketing has become pervasive in society. Merchants continuously seek advertising and promotion to develop and grow their businesses. Traditionally, a merchant or business establishes a relationship with a marketing company to promote its goods or services. The marketing company then works to distribute information promoting the goods or services to the public. The marketing company may create promotional material and actively promote the merchant or business. Alternatively, the marketing company may simply accept promotional material and distribute such material to the public.

This process, with the marketing company functioning as an intermediary between a merchant and its customers, is not streamlined and typically adds additional costs when promoting a merchant or business. In addition, this intermediary processes necessarily hinders direct communication between a merchant or business and its customers.

From the discussion that follows, it will become apparent that the present invention addresses the deficiencies associated with the prior art while providing numerous additional advantages and benefits not contemplated or possible with prior art constructions.

### SUMMARY OF THE INVENTION

An analytics system and method are disclosed herein. The analytics system provides the benefit of automatic tracking of consumer activity with regard to a promotion being conducted by a merchant. This is highly advantageous in that it provides feedback to the merchant so that the merchant may quickly identify promotions or aspects thereof, that are successful and those that are not. The merchant can then revise or update its marketing strategy to develop or grow its business. The analytics system may be used as a platform for electronically distributing promotions to consumers. The consumer activity surrounding the promotions may then be tracked to provide feedback to merchants while also providing discounts or other benefits to consumers. Various reports may be generated for the merchant to evaluate the performance of its promotions.

The analytics system may have various embodiments. For example, in one embodiment an analytics system for recording consumer activity is provided. Such a system may comprise one or more servers configured to transmit one or more promotions to one or more consumer devices, and to receive interaction data and demographic data from the consumer devices. Machine readable code fixed on a tangible medium may also be provided. The machine readable code may be configured to present the promotions on the consumer devices and to generate the interaction data based on user input at the consumer devices. The machine readable code may be executable by the consumer devices. In this manner a consumer device may execute the machine readable code to present promotions and report interaction data related thereto. It is noted that the machine readable code may also be configured to transmit the interaction data from a consumer device to the servers when a promotion is redeemed.

One or more storage devices may be configured to store the interaction data and demographic data, such as age, sex, residence, and other demographic information of a consumer or user. It is contemplated that the machine readable code may be configured to request and accept demographic information at a consumer device and transmit the demographic information to the servers. The interaction data may be stored associated with the demographic data. In this manner, the interaction data and demographic data for a particular consumer may be retrieved individually or in aggregate from the storage devices.

For example, one or more processors of the servers may be configured to generate an output combining interaction data from a plurality of users. As another example, the processors may be configured to generate an output combining the interaction data and associated demographic data from the plurality of users. It is contemplated that the report may comprise a report having types of interaction data grouped by one or more categories of the demographic data. The categories may be a user location category and/or a user age category for example. This allows the interactions with promotion by consumers to be categorized by their demographic information. For example, redemptions or other interactions with promotions could be grouped by age, sex, residence, etc. . . . of consumers.

The interaction data may identify various consumer activities. For instance, the interaction data may identify consumer activity such as the viewing of a promotion, redemption of a promotion, deletion of a promotion, saving of a promotion, and/or sharing of a promotion.

In another exemplary embodiment, an analytics system for recording consumer activity may comprise a promotion distribution system and an activity monitor. The promotion distribution system may be configured to transmit one or more promotions to one or more consumer devices via one or more communication devices.

The activity monitor may be configured to receive from the consumer devices interaction data identifying a consumer activity that occurred with regard to the promotions, and associate the interaction data with demographic data for one or more consumers. The interaction data may be stored for subsequent retrieval by one or more merchants. Similar to above, the interaction data may identify consumer activity that occurred with regard to the promotions at the consumer devices. For instance, the interaction data may identify the viewing of a promotion, redemption of a promotion, sharing of a promotion, saving of a promotion, and/or deletion of a promotion.

The activity monitor may operate in various ways. For example, the activity monitor may be configured to receive the demographic information from the consumer devices. Alternatively or in addition, the activity monitor may be configured to group types of interaction data according to one or more categories of the demographic data.

A storage device having machine readable code stored thereon may be included in the analytics system. The machine readable code may be configured to cause the consumer devices to record user activity at the consumer devices in the form of interaction data and to transmit the interaction data to the activity monitor.

Promotions provided by the analytics system may come in various forms. For instance, the promotions may comprise an offer redeemable for a consumer benefit such as a discount or an offer for at least one free item. Alternatively or in addition, the promotions could comprise marketing information for the merchants.

Various methods of providing analytic data for merchants are also disclosed herein. For example, in one embodiment a method for providing analytics with an analytics system is provided. Such a method may comprise providing one or more servers configured to distribute one or more promotions, providing machine readable code configured to present the promotions on one or more consumer devices, and receiving interaction data at the servers. Similar to above, the interaction data may include one or more identifiers configured to identify at least one user activity that occurred with regard to the promotions. The machine readable code may be configured to collect the interaction data at the consumer devices and transmit the interaction data to the servers.

Demographic data may be received at the servers and the interaction data may be associated with the demographic data. The interaction data may be categorized, sorted, or grouped according to one or more categories of the associated demographic data to generate a report. For example, interaction data for one or more promotions may be grouped according to the age, sex, residence, and/or other demographic data for one or more consumers.

The method may also include receiving an input at the consumer devices indicative of the user activity, such as the viewing of a promotion, redemption of a promotion, sharing of a promotion, saving of a promotion, and/or deletion of a promotion. Alternatively or in addition, the interaction data may indicate that a consumer has redeemed a promotion at a particular merchant location. It is noted that the number of times a user shares a promotion may be recorded at the servers. This may then be reviewed by the merchants.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary analytics system in communication with merchant and consumer devices;

FIG. 2 is a block diagram illustrating components of an exemplary analytics system;

FIG. 3A illustrates an exemplary promotion;

FIG. 3B illustrates an exemplary promotion;

FIG. 4 is a flow diagram illustration operation of an exemplary analytics system; and

FIG. 5 illustrates an exemplary report generated by an analytics system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the analytics system herein collects information regarding the usage, success, or lack thereof of a merchant's promotional activity. The analytics system may do so in an automated fashion so that this information can be collected without interrupting purchase transactions or annoying consumers. In addition, the analytics system may combine the collected information and display it such that it may be easily reviewed for pertinent data points. Using this data, merchants may alter their promotional strategy such as by altering one or more coupons, offers, or other marketing materials. In addition, merchants may identify promotions that work well for their particular businesses.

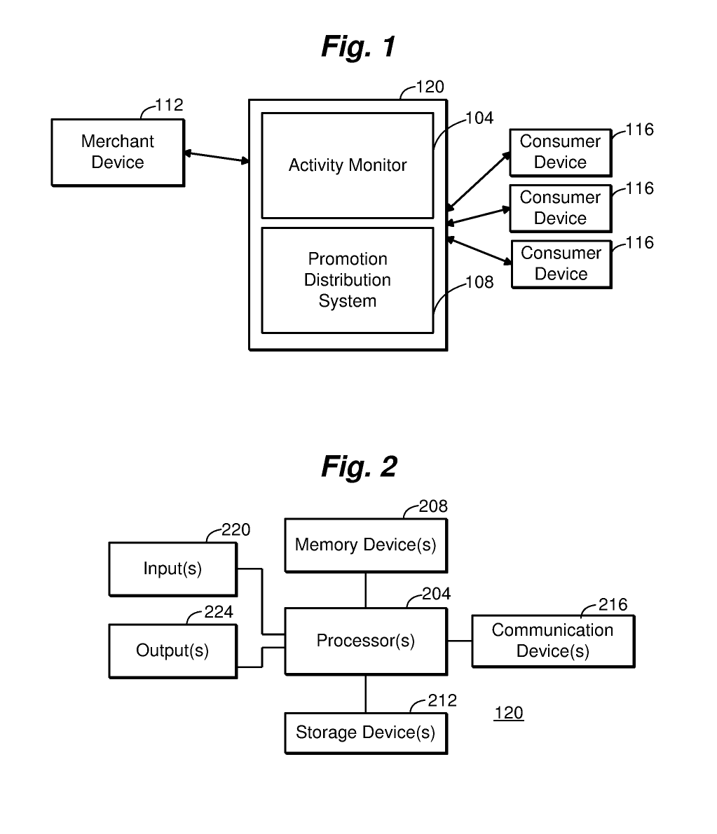

The analytics system will now be described with regard to FIG. 1. In one or more embodiments, the analytics system 120 may comprise one or more subsystems. For example, as shown, the analytics system 120 comprises an activity monitor 104 and a promotion distribution system 108. It is contemplated that the analytics system 120 could comprise either or both these subsystems in some embodiments.

In general, the promotion distribution system 108 allows merchants to distribute their promotions to consumers. In some embodiments, as will be described further below, the promotion distribution system 108 may also allow merchants to create their own promotions and/or may accept promotions directly from merchants for distribution to the consumers. Merchants may access the promotion distribution system 108 with a merchant device 112, such as a computer or other device.

Typically, promotion distribution will occur electronically, such as by wired or wireless transmission, to a consumer device 116 belonging to a consumer. For example, the consumer device 116 may be a mobile device such as a cell phone, PDA, laptop, tablet, or smart phone. A mobile device is advantageous in that the consumer can have such a device on his or her person virtually everywhere. It is noted that the consumer device 116 could be non-mobile device such as a desktop computer or the like, but typically the client device will be mobile to allow promotions to be received virtually anywhere.

It is contemplated that a merchant device 112 and consumer device 116 could both be various devices capable of accessing and communicating with the analytics system 120. For example, any mobile or non-mobile device capable of properly communicating with the analytics system 120 could be a merchant device 112 or a client device 116. This permits both merchants and consumers to use the analytics system 120 from almost anywhere. It is noted that such a device may be configured with machine readable code stored on a memory device to properly communicate (and thus access) the analytics system 120.

The activity monitor 104 will typically be configured to monitor usage or other activities related to the promotions. The activity monitor 104 may monitor activities at the analytics system 120, at the consumer devices 116, or both. For example, the activity monitor 104 may monitor the number of promotions sent, the number received, the number used or redeemed. The activity monitor 104 may also monitor consumer activities and characteristics. For example, the activity monitor 104 may monitor where promotions are used and the demographics of consumers utilizing the promotions. The activity monitor 104 may also record the information it monitors or collects. In this manner, the collected information may be retrieved for analysis and reporting to a merchant 112.

As shown in FIG. 1, the activity monitor 104 and promotion distribution system 108 are within an analytics system 120. It is noted that though illustrated as one device, the activity monitor 104 and promotion distribution system 108 (and/or other subsystem(s)) may be separate components and may be remote from one another. For example, various subsystems of the analytics system 120 may be remote from one another and communicate via one or more network or other communication links, if necessary. In addition, it is contemplated that a single activity monitor 104 may monitor promotion activity resulting from or at multiple promotion distribution systems 108. In this manner, consumers 116 may utilize a variety of promotion distribution systems 108, such as their own promotion distribution systems or third party distribution systems in addition to or instead of the promotion distribution system of the analytics system 120.

FIG. 1 also shows how merchant devices 112 and consumer devices 116 may communicate with the analytics system 120. In one or more embodiments, merchant devices 112 may effectuate the distribution of promotions from the promotion distribution system 108 and view information collected by the activity monitor 104 via a communication link with the analytics system 120. Consumer devices 116 may communicate information regarding the use, success or lack thereof of one or more promotions to the activity monitor 104, or the activity monitor may request such information from the mobile devices.

In one or more embodiments, the analytics system 120 may be a hardware device configured to operate as described herein. For example, the analytics system 120 may be a server, network appliance or other device that performs the functions disclosed herein. FIG. 2 is a block diagram illustrating an exemplary analytics system 120. As can be seen, the analytics system may comprise one or more processors 204, memory devices 208, storage devices 212, communication devices 216, input devices 220, and/or output devices 224. It is noted that in some cases, memory devices 208 and storage devices 212 may perform similar data storage functions and thus both may not be provided in some embodiments.

In general, a processor 204 will be configured to control or operate various components of the analytics system 120 to provide the functionality described herein. In one or more embodiments, the processor 204 may operate according to one or more instructions. These instructions may be hard wired into the processor 204 or may be machine readable code retrieved from a storage medium for execution by the processor. For example, in one or more embodiments, the instructions may be retrieved from a storage device 212 for execution by the processor 204. Some exemplary storage devices 212 may utilize magnetic, optical, or flash based storage technology. The instructions may be configured such that the analytics system 120 has activity monitoring capability, promotion distribution capability, or both.

A storage device 212 may also or alternatively store promotion information. For example, one or more coupons or offers may be stored on the storage device such as for the promotion distribution system 108 to distribute. As another example, the storage device 212 may store the information collected by the activity monitor 104. It is noted that the storage device 212 may be a local storage device, such as a hard drive or the like within the same enclosure of the processor 204. Alternatively, the storage device 212 may be remote from the processor 204, such as an external storage device or network attached storage or the like. One or more communication devices 216 may be used to communicate which such storage devices 212.

One or more memory devices 208 may be provided in some embodiments. Typically, a memory device 208 is used for short term storage such as RAM or cache memory. A memory device 208 may be read only, such as ROM, or read write, such as in the case of RAM or cache memory. Since, as described herein, memory devices 208 and storage devices 212 are both capable of retrievably storing data, it is contemplated that they may be used interchangeably at least for some tasks.

As stated, the analytics system 120 may comprise one or more communication devices 216 configured to allow communication with one or more remote devices. For example, the analytics system 120 may communicate with devices, such as merchant devices 112 and/or consumer devices 116, via a communication device 216. Various communication devices 216 may be provided so that the analytics system 120 can communicate through a variety of communication links or mediums. For example, wired or wireless communication devices 216 may be provided. In addition, the communication devices 216 may utilize various communication protocols to establish communications and to transfer data. In a networked embodiment for example, a communication device 216 may utilize TCP/IP (or other communication protocol).

It is contemplated that the analytics system 120 may be controlled remotely through a communication device 216, such as at a remote terminal (e.g., a merchant device 112) in communication with the analytics system. Alternatively or in addition, the analytics system 120 may have one or more input devices 220 and/or one or more output devices 224. For example, the analytics system 120 may have a keyboard, mouse, or other input device 220 to allow a user to interact with and control the analytics system 120. The analytics system 120 may have a display screen, speakers, and other output devices 224 to provide feedback of various types to the user.

The analytics system 120 may have different types of users. For example, merchants may utilize the analytics system 120 by requesting, receiving, and/or reviewing information regarding their promotion activity that has been collected by the activity monitor. Merchants may also create promotions of various sorts and distribute them using the promotion distribution system of the analytics system 120. Consumers may utilize the analytics system 120 by requesting, receiving, and/or redeeming promotions provided by the merchants. The analytics system 120 may also have administrative users or administrators that maintain, configured, and/or upgrade the analytics system. The analytics system's users may interact with the analytics system in these ways through the system's communication device(s) 216, input device(s) 220, and/or output device(s).

As stated, the analytics system 120 generally utilizes its activity monitor 104 to track the usage, success, or lack thereof of a merchant's promotions by monitoring consumer activity related to the promotions the merchant has distributed (i.e., provided to consumers). FIG. 3A illustrates an exemplary promotion 304 that may be distributed by the analytics system 120, such as via its promotion distribution system. It is noted that the analytics system 120 may provide a user interface (e.g., a graphical user interface) or other interface which accepts promotion information that forms a promotion or coupon. Typically, the promotion data that forms a promotion 304 will be received via an input device or a communication device of the analytics system. For example, the merchant may utilize a keyboard and mouse or his or her merchant device to send a promotion 304 to the analytics system 120. The analytics system 120 may then store the promotion on a storage device for subsequent retrieval and distribution to one or more consumer devices.

Typically, the promotion 304 will be electronic and thus may be displayed on a display screen for viewing. For example, a promotion 304 may be displayed on screen of a consumer device 116. Promotions 304 may include various information. For example, a promotion 304 may provide an enticing offer or other benefit to a consumer (such as shown in FIG. 3A). In addition or alternatively, a promotion 304 may provide marketing information or merchant information to a consumer (such as shown in FIG. 3B).

FIG. 3A illustrates an exemplary promotion 304 comprising an offer 312. In the example of FIG. 3A, the offer 312 is for buy one get one free of an item at the offering merchant's business. An offer 312 may include various discounts or consumer benefits. Also, the offer 312 may include one or more images, animations, videos, and/or sounds if desired. Merchant information 308 may be part of a promotion 304 in some embodiments. For example, merchant information 308 such as the name, location, website, and/or contact information for a merchant may be provided. Merchant information 308 may optionally include a description of the merchant or its goods and services.

Since the promotion 304 is typically electronic, it may accept user input. For example, the promotion 304 may have one or more controls, such as buttons, sliders, switches, scroll bars that can be used to interact with the promotion, such as to retrieve additional information, redeem the promotion, share the promotion, and/or save the promotion for later use. The promotion 304 shown in FIG. 3A provides input buttons that may be used to execute various functionality. To illustrate, the promotion 304 of FIG. 3A has a “Redeem” button 316, a “Share” button 320, and a “Save” button 324. It is noted that the promotion 304 of FIG. 3A is exemplary and that fewer or additional buttons may be provided. For example, only a “Redeem” button 316 may be provided in some embodiments.

The “Redeem” button 316 may be configured to allow the offer 312 to be redeemed when the “Redeem” button is engaged. For example, pressing the “Redeem” button 316 may trigger a redemption process whereby the offer 312 is redeemed to give a consumer the discount or other benefit presented therein. The redemption process may include confirmation that the offer 312 is valid. The redemption process may also or alternatively include expiring or deactivating the offer 312 so that it can not be used again. For example, the offer 312 may be identified on the analytics system, such as in a database, and be marked as redeemed, expired, or deactivated once the offer has been redeemed.

In one embodiment, the redemption process may include scanning or reading one or more barcodes or other identifiers at a merchant's location. For example, a consumer device may scan a barcode using a scanner, camera, or the like. A consumer device may also or alternatively read an identifier via RF signals using one or more transceivers. Typically, the barcode will be used to identify a merchant, such as to verify that an offer 312 is being redeemed at the merchant that provided it. A consumer may redeem an offer simply by reading the identifier with his or her device. Alternatively, the consumer may first engage the “Redeem” button and then read the identifier to allow the system to verify the offer 312 prior to redeeming it. If the identifier does not match, the offer may not be successfully redeemed in one or more embodiments.

The “Share” button 320 may be used to share a promotion 304 with others. For example, the promotion 304 may be transmitted to other consumers via social networking sites, email, SMS, or other communication mediums. Consumers receiving a shared promotion may be permitted to redeem the promotion 304 themselves in one or more embodiments.

The “Save button 324 may be used to store or tag promotions 304. The consumer can then retrieve the promotions 304 he or she has saved, and redeem them if desired. In this way, the consumer device can help a consumer remember particular promotions 304 and allow them to be easily retrieved for redemption.

Interactions with a promotion 304 may be transmitted from a consumer device to the analytics system. In one or more embodiments, the interactions may be recorded by an activity monitor of the analytics system, such as described above. Interactions may include, viewing the promotion, redeeming the promotion, saving the promotion, deleting the promotion, and sharing the promotion. On some consumer devices, a consumer may visit a merchant's website or call a merchant directly from the promotion 304, such as by engaging a button, link, or the like presented with the promotion 304. When a user engages in such interaction, data identifying the interaction may be transmitted from the consumer device to the analytics system for storage. For example, a message identifying the type of interaction, user engaging in the interaction, time of interaction, promotion undergoing interaction, and/or location of the user may be sent to the analytics system.

It is contemplated that the consumer device may also collect demographic information from a consumer. For example, the consumer may provide contact information (e.g., email, phone number, address), his or her age or date of birth, sex, and other information. Demographic information may be collected when a user first signs up or logs in, such as when creating a user account. This information may then be stored by the analytics system so that it need not be entered again. Typically, the analytics system will allow the consumer to decide what information the consumer wishes to provide, though it is contemplated that some demographic information may be required in some embodiments. The information may but need not be precise. For example, rather than a residence address, a consumer may provide a zip code or city and state. As another example, the consumer may provide an age range rather than a particular age or date of birth.

FIG. 3B illustrates another exemplary promotion 304. As can be seen this promotion 304 also includes merchant information 308 as well as a “Share” button 320 and a “Save” button 324. The promotion 304 also has marketing information 328. In this embodiment, the marketing information 328 is provided instead of the offer 312, such as that shown in FIG. 3A. Marketing information 328 may be information, that promotes a merchant without offering a benefit per se. This includes a variety of information. For example, marketing information 328 may explain the advantages of utilizing a particular merchant, provide information about the merchant, present announcements from a merchant, and the like. In general, marketing information 328 cannot be redeemed, but may be used to increase a merchant's consumer base and advertise the merchant.

Similar to above, the “Share” button 320 may be used to share the promotion 304 with other consumers. Here, engaging the “Share” button 320 would typically cause the marketing information 328 to be shared with other consumers through social media, email, SMS, or other communication mediums. Also similar to above, the “Save” button 324, when engaged, would store the promotion 304 for convenient retrieval. This is beneficial in helping the consumer remember new merchants that may need in the future. The consumer may save such merchants' promotions 304 and refer back to them when their services are needed.

Interactions with promotions 304 containing marketing information 328 may also be transmitted to the analytics system, such as described above. For example, interactions such as viewing the promotion 304, sharing the promotion, saving the promotion, deleting the promotion, or the like may be transmitted to a communication device of the analytics system. In this manner, promotions 304 of various types can be monitored by the analytics system's activity monitor.

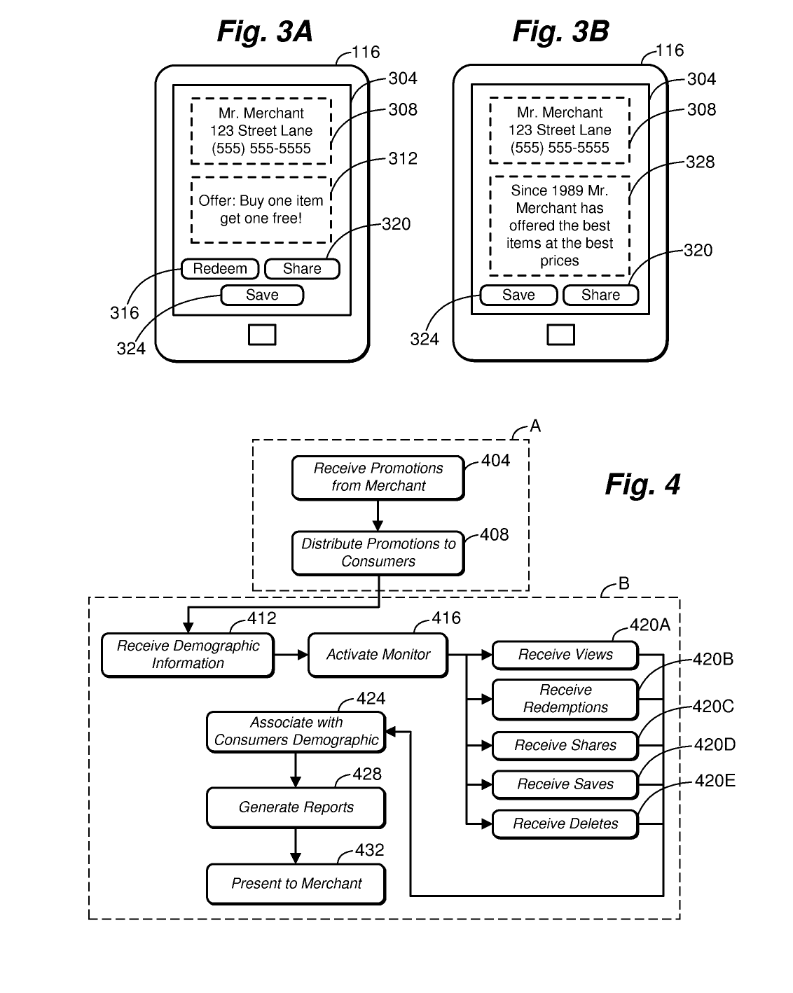

FIG. 4 is a flow diagram illustrating operation of an exemplary analytics system. Portion A and Portion B as indicated by the dashed lines show an exemplary division between tasks performed by the promotion distribution system and activity monitor, respectively. It is noted that various tasks may be performed by various components of the analytics system and that the promotion distribution system and activity monitor may perform tasks other than those shown in the example of FIG. 4. Though shown in a particular order in FIG. 4, it will be understood that various steps may be performed in various sequences.

At a step 404, one or more promotions may be received from one or more merchants. As disclosed above, the merchants may use their merchant devices to transmit data forming their promotions to the analytics system. It is contemplated that merchants may identify whether marketing information and/or offers are in a promotion. In addition, the merchants may define a start date and an end or expiration date for a promotion. The promotions may then be stored.

At a step 408 the analytics system may distribute the promotions to one or more consumers. Typically, this will occur by sending individual promotions to one or more consumer devices. For example, the analytics system may transmit data via a network or other communication medium to one or more consumer devices. It is noted that consumers may specify which types of promotions they wish to receive. For example, consumers may identify categories of merchants (e.g., auto, beauty, food, etc. . . . ) from which promotions may be received. Likewise, merchants may identify a category in which their promotions belong (e.g., auto, beauty, food, etc. . . . ). This allows the merchants to self-select which categories their promotions belong in.

At a step 412, the analytics system may receive demographic information from individual consumers. It is noted that demographic information may be received at any time and need not be received after the distribution of promotions. In one embodiment, demographic information may be received via an account registration or creation process. For example, a consumer may be prompted to create an account by entering authorization information (e.g., username and password) and any demographic information the consumer wishes to provide (e.g., sex, age or age range, residence address or residence zip code/city and state).

The account is beneficial in that it allows demographic information to be easily associated with the activities/interactions of consumers. In some embodiments, the consumer may not be permitted to view promotions until an account has been created. In other embodiments, the consumer may be permitted to view but not redeem promotions until an account has been created.

At a step 416, monitoring by the analytics system may be activated. It is noted that this step may occur at other times. For example, monitoring may be activated before promotions have been received at step 404, in some embodiments. In general, activation of monitoring causes the analytics system to be in a state where it is ready to receive data from consumer devices. Typically, the data receivable on activation will be the data identifying or recording user interactions with merchant promotions.

FIG. 4 illustrates some exemplary interaction data that may be received. As can be seen, interaction data reporting the viewing, redemption, sharing, saving, or deletion of a promotion may be received by the analytics system at steps 420A-420E, respectively. For example, as described above, if a consumer views Promotion X, his or her consumer device may report that Promotion X has been viewed. The consumer device may also identify itself and/or the consumer that viewed Promotion X. For example, the consumer device may report that Promotion X was viewed by Consumer 1 using Device 23. An identification scheme whereby individual consumer devices and consumers may be uniquely identified may be used to accomplish this. In addition, the consumer device may report other information as part of interaction data. For example, the date and/or time of interaction, location of the consumer device, or both may be reported.

At a step 224, the interaction data received at step 220 may be associated with data from a consumer's account. For example, data identifying a consumer or the consumer's device may be used to associate the consumer's activity or interaction with regard to a promotion to the consumer's account information. Since the account information may contain demographic information, the interaction data may be associated with demographic information in this manner. To illustrate, if Consumer 1 previously provided an Age Range 1 and/or Zip Code 1, Consumer 1's interaction with Promotion X can now be associated with this demographic information by the analytics system. In this manner, it is now known that at least one consumer of Age Range 1 and at Zip Code 1 has at least viewed Promotion X. It can thus be seen that as a number of consumers view (or conduct other interactions with promotions) a collection of interactions for various promotions can be built and stored.

At a step 428, the stored interaction data may be used to generate one or more reports of various sorts. It is contemplated that the analytics system may accept various queries or requests and generate reports accordingly. For example, a merchant may request the age range of all consumers that viewed a particular promotion. It can be seen that the merchant may include various characteristics of interactions and consumer demographics in his or her request. For example, rather than or in addition to views of a promotion, the merchant can request redemptions, shares, saves, and/or deletions of a promotion. Likewise, the merchant can request a report including one or more of such interactions of a promotion for consumers from one or more particular zip codes. In addition, the merchant may request a report for multiple promotions rather from a single promotions. For example, the merchant may request all redemptions (or redemptions for consumers of a particular demographic) for all of his or her promotions, a category of his or her promotions, or other promotions sharing at least one common characteristic.

Once one or more reports are generated, they may be provided to the requesting merchant at a step 432. In one or more embodiments, this may occur by transmitting the report to the merchant's merchant device where it may be viewed, printed, or otherwise used. For example, the report may be a file, webpage, or other data that is presentable via a merchant device. In some embodiments, the report may be interactive allowing the merchant to focus on particular aspects of the report. In addition, it is contemplated that the merchant may alter or change the request that generated the report to receive a different report as he or she desires. The request and any changes thereto may be generated and sent from the merchant's merchant device.

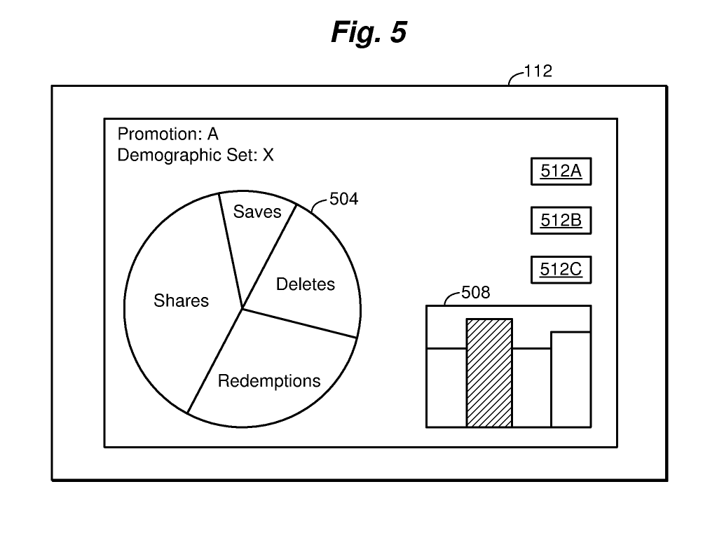

The report may comprise text, graphics, and other information. FIG. 5 provides an exemplary report presented on a merchant device 112. As can be seen, the merchant has requested a report on Promotion A in FIG. 5. The report comprises a pie chart 504 identifying the percentage of consumers shared, saved, deleted, or redeemed Promotion A. A bar graph 508 or other data visualization (including text) could be used as well or instead of the pie chart 504. In addition, a single report may contain multiple data visualizations for multiple merchant requests or queries. One or more buttons or controls 512A-512C may be provided to allow the merchant to interact with a report. For example, the merchant may alter his or her request using one or more controls 512A-512C. It is contemplated that data visualizations may also be interactive. For example, the merchant may click on or otherwise engage a data visualization to “zoom in” on particular data sets. To illustrate, clicking the “Deleted” portion of the pie chart 504 may cause a new data visualization to be displayed that identifies demographics of consumers that have deleted Promotion A.

This provides a report that is easily understandable to the merchant. The merchant can then adjust his or her promotions to increase or decrease particular types of interactions with his or her promotions. For example, the merchant may alter promotions to increase redemptions over saves. The merchant may run multiple reports for a comparison between various promotions. In this manner, the merchant can quickly identify promotions that accomplish the merchant's goals and characteristics thereof. The merchant can then include such characteristics in his or her other promotions to increase their effectiveness or success rate. In addition, the merchant may define his own measure(s) of success and change his or her promotions to meet such measure(s).

The analytics system is highly advantageous to merchants, while providing repeated benefits to consumers in the form of merchant promotions. As can be seen from the above, the analytics system automatically collects consumer activity and interaction with merchant's promotions so that merchants can determine their success or lack thereof virtually in real time. Since consumers receive the benefit of the merchant's promotions, the consumers also benefit while being enticed or encouraged to continue using the analytics system.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An analytics system for recording consumer activity comprising:
one or more servers configured to transmit one or more promotions to one or more consumer devices, and to receive interaction data and demographic data from the one or more consumer devices;
machine readable code fixed on a tangible medium and configured to present the one or more promotions on the one or more consumer devices and to generate the interaction data based on user input at the one or more consumer devices, the machine readable code being executable by the one or more consumer devices;
one or more storage devices configured to store the interaction data and demographic data, wherein the interaction data is stored associated with the demographic data; and
one or more processors at the one or more servers configured to generate an output combining interaction data from a plurality of users.

2. The analytics system of claim 1, wherein the interaction data identifies user activity selected from the group consisting of a viewing of a promotion, a redemption of a promotion, a deletion of a promotion, a saving of a promotion, and a sharing of a promotion.

3. The analytics system of claim 1, wherein the one or more processors are configured to generate an output combining the interaction data and associated demographic data from the plurality of users.

4. The analytics system of claim 1, wherein the output comprises a report having types of interaction data grouped by one or more categories of the demographic data.

5. The analytics system of claim 4, wherein the one or more categories are selected from a group consisting of a user location category and a user age category.

6. The analytics system of claim 1, wherein the machine readable code is configured to transmit the interaction data from a consumer device to the one or more servers when a promotion is redeemed.

7. The analytics system of claim 1, wherein the machine readable code is configured to request and accept demographic information at a consumer device and transmit the demographic information to the one or more servers.

8. An analytics system for recording consumer activity comprising:
a promotion distribution system configured to:
transmit one or more promotions to one or more consumer devices via one or more communication devices; and
an activity monitor configured to:
receive from the one or more consumer devices interaction data identifying a consumer activity that occurred with regard to the one or more promotions;
associate the interaction data with demographic data for one or more consumers; and
store the interaction data for subsequent retrieval by one or more merchants.

9. The analytics system of claim 8, wherein the interaction data identifies consumer activity that occurred with regard to the one or more promotions at the one or more consumer devices.

10. The analytics system of claim 8, wherein the interaction data identifies consumer activity selected from the group consisting of a viewing of a promotion, a redemption of a promotion, a sharing of a promotion, a saving of a promotion, and a deletion of a promotion.

11. The analytics system of claim 8, wherein the activity monitor is configured to receive the demographic information from the one or more consumer devices.

12. The analytics system of claim 8, wherein the activity monitor is configured to group types of interaction data according to one or more categories of the demographic data.

13. The analytics system of claim 8 further comprising a storage device having machine readable code stored thereon, the machine readable code configured to cause the one or more consumer devices to record user activity at the one or more consumer devices in the form of interaction data and to transmit the interaction data to the activity monitor.

14. The analytics system of claim 8, wherein the one or more promotions comprise an offer redeemable for a consumer benefit selected from the group consisting of at least one discount and at least one free item.

15. The analytics system of claim 8, wherein the one or more promotions comprise marketing information for the one or more merchants.

16. A method for providing analytics with an analytics system comprising:
providing one or more servers configured to distribute one or more promotions;
providing machine readable code configured to present the one or more promotions on one or more consumer devices;
receiving interaction data at the one or more servers, the interaction data comprising one or more identifiers configured to identify at least one user activity that occurred with regard to the one or more promotions;
receiving demographic data at the one or more servers;
associating the interaction data with the demographic data; and
grouping the interaction data according to one or more categories of the associated demographic data to generate a report.

17. The method of claim 15, wherein the machine readable code is configured to collect the interaction data at he one or more consumer devices and transmit the interaction data to the one or more servers.

18. The method of claim 15 further comprising receiving an input at the one or more consumer devices indicative of the at least one user activity selected from the group consisting of a viewing of a promotion, a redemption of a promotion, a sharing of a promotion, a saving of a promotion, and a deletion of a promotion.

19. The method of claim 15, wherein the interaction data indicates that a consumer has redeemed a promotion at a particular merchant location.

20. The method of claim 15 further comprising recording a number of times a user shares one or more of the one or more promotions at the one or more servers.
